(19) United States
(12) Patent Application Publication
(10) Pub. No.: US 2001/0048765 A1
(43) Pub. Date: Dec. 6, 2001

(54) Color characterization for inspection of a product having nonuniform color characteristics

(76) Inventors: Steven Yi, Vienna, VA (US); John L. Perry, Oak Hill, VA (US); Thomas D. Gamble, Annandale, VA (US)

Correspondence Address: NIXON PEABODY, LLP, 8180 GREENSBORO DRIVE, SUITE 800, MCLEAN, VA, 22102, US

(21) Appl. No.: 09/793,397

(22) Filed: Feb. 27, 2001

Related U.S. Application Data
(60) Provisional application No. 60/185,684, filed on Feb. 29, 2000.

(51) Int. Cl. G06K 9/00

(52) U.S. Cl. 382/165

(57) ABSTRACT

An apparatus and method is provided for classification of a product bearing nonuniform color patterns. A learning and classification mode is employed where the apparatus is trained with image data derived by a CCD color camera and lighting from a plurality of reference colored products, and this image data is stored to provide product color classes and subclasses. Then image data from an unknown product is compared with the stored class and subclass data to provide a classification for the unknown product.

This application is a continuation-in-part application of Ser. No. 60/185,684 filed Feb. 29, 2000.

### BACKGROUND OF THE INVENTION

In the past, a number of prior art optical systems have been developed to sense the color characteristics of an object. Generally these systems have been designed to sense uniform color characteristics where a uniform color extends over a substantial area of the object. Such systems do not operate effectively for objects bearing non-uniform color patterns where many colors or color variations are mixed to extend in a non-uniform manner over the surface of an object. Non-uniform color patterns are found in many items such as carpeting, textiles and food items with a non-uniform surface pattern formed by the application of colored materials to the food surface.

A need has arisen for a product inspection system which will effectively inspect products bearing non-uniform color patterns.

### SUMMARY OF THE INVENTION

It is a primary object of the present invention to provide a novel and improved method and apparatus for inspection of a product bearing nonuniform color patterns.

Another object of the present invention is to provide a novel and improved method and apparatus for inspection of a product bearing nonuniform color patterns which includes a color characterization imaging system having a digital color sensing device centrally located relative to linear light sources positioned between the color sensing device and a product to be inspected.

A further object of the present invention is to provide a novel and improved method for inspection of a product bearing nonuniform color patterns which includes using a digital color sensing device and associated light sources to obtain training image data relative to a plurality of nonuniform color patterns and storage of the nonuniform color patterns for subsequent comparison with a nonuniform color pattern sensed by the digital color sensing device from a product to be inspected.

A still further object of the present invention is to provide a novel and improved method for inspection of a product bearing nonuniform color patterns including an illumination invariant technique which enables an inspection to be made even if the intensity of lighting used varies over time. This eliminates the need for precise CCD camera calibration and lighting control.

### BRIEF DESCRIPTION OF THE DRAWINGS

FIG. 1 is a block diagram of the color characterization inspection device of the present invention;

FIG. 2 is a sectioned plan view of the color characterization imaging system of FIG. 1;

FIG. 3 is a sectional view of the color characterization imaging system of FIG. 2;

FIG. 4 is a flow diagram of the training and classification procedure in accordance with the method of the present invention;

FIG. 5 is a flow diagram of the color characterization comparison method of the present invention; and

FIG. 6 is a diagram of a two system calibration method of the present invention.

### DESCRIPTION OF THE PREFERRED EMBODIMENTS

Since food products can have very diverse, non-uniform color patterns, our invention will be hereinafter described relative to the inspection of food products. It is to be understood, however, that this is for purposes of illustration only, and any product bearing a non-uniform color pattern can be inspected in like manner.

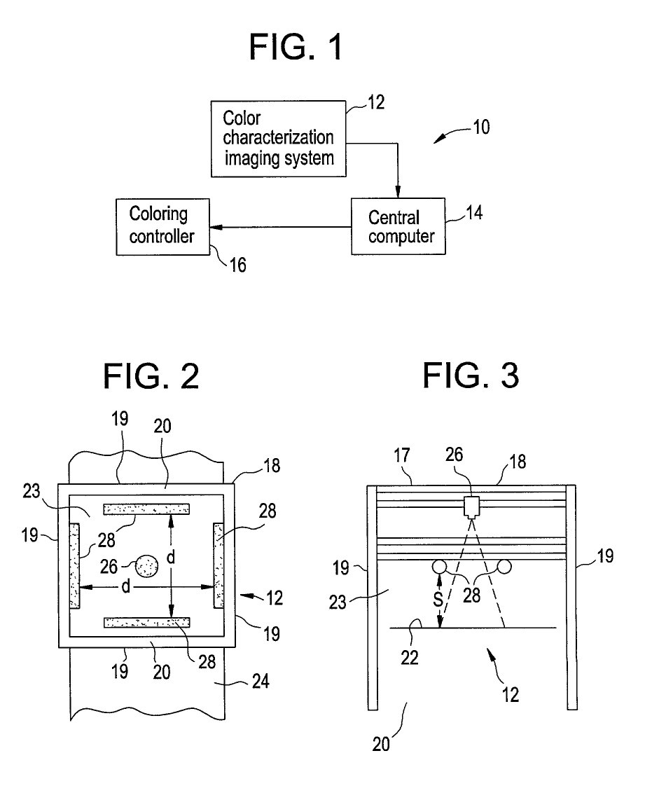

We have developed a complete color characterization system for product inspection based upon the physical color appearance of a product having non-uniform color characteristics. For example, food products can vary in their color appearance for a number of reasons, including flavorings, toppings, seasonings, flours, spicing, etc. The system of the present invention can monitor and measure the coloring of food in real-time. The functionality of this system is many: it can distinguish different types of colored food product, it can detect for the presence or absence of coloring on food product, and it can also compute the precise percentage of coloring amount on a food product. Finally, the system can be used as a feedback control mechanism to adjust the amount of coloring placed on the food product in real-time. This is illustrated generally in FIG. 1 where the color characterization inspection system indicated generally at 10 includes a color characterization imaging system 12 which under the control of a central computer 14 inspects a product having non-uniform color characteristics and provides real-time data to the central computer 14. The central computer can then provide control signals to a coloring controller 16 to vary the color of the sensed product in conformance with criteria stored by the central computer. For example, if the inspected product is a seasoned food product, the coloring controller would vary the amount of seasonings applied to the surface of the product in response to control signals from the central computer.

The system of the present invention uses a digital color sensing device, such as a CCD camera and lighting system to inspect a product having a non-uniform color pattern. For an inspection of this type, the proper arrangement of camera and lighting is important to the successful implementation of our approach. With reference to FIGS. 2 and 3, the color characterization imaging system 12 includes an enclosed housing 18 having a top wall 17 and four opposed sidewalls 19 to enclose a product surface to be inspected. The lower portion of two opposed sidewalls include an open portion 20 to receive a product to be inspected. The product surface 22 can be stationary or can be supported by a conveyor belt 24. Mounted within an imaging chamber 23 defined by the housing 18 is a digital color sensing device, such as a CCD camera 26, which is centrally located relative to illumination sources 28 mounted in spaced relationship below and extending on at least two opposed sides of the CCD camera. These illumination sources are preferably linear light sources, such as elongate fluorescent lights and the separation distance d between these light sources should be within a range of from one to two times the distance S from the light sources to the product surface 22. Ideally, the light sources will extend on all four sides of the CCD camera and will be spaced 1.4 times the distance S. This will produce relatively constant illumination over the surface 22 which is scanned by the CCD camera 26.

For purposes of description, the digital color sensing and imaging device will be hereinafter described as a CCD camera, although other known color sensing devices which provide a digital output can be used in place of the CCD camera.

The system 10 of the present invention works in a learning and classification mode wherein it is first trained with a set of training image data derived from the CCD camera 26 and lighting system 28 which will subsequently be used to inspect a product having a non-uniform color pattern. For example, once the system is trained and learns the characteristics desired for a colored product, it then stores and uses these characteristics in the central computer 14 as a reference feature for the classification of non-uniform color products subsequently inspected by the color characterization imaging system.

We have designed an illumination invariant and color image processing technique which enables the system to work properly even if the intensity of lighting varies over time, which is typical of many illumination systems. The color image processing algorithm uses a unique approach to differentiate three dimensional color space between trained data and test data. Unique color features are used for color classification. Experimental data shows that a 25% to 30% intensity decrease still allows reliable color classification. This design eliminates the need of precise camera calibration, lighting control, and other environmental control. A special feature database derived from training images is used for the classification of an unknown colored product such as a food product. An interpolation method is used to compute the percentage of the coloring on the product. Also, the system averages over multiple test images to produce a more statistically repeatable result. The system can be calibrated with other external product data, if available. Experimental data shows an accurate classification rate of 99%, and the coloring percentage measurement can be reached within 1% resolution.

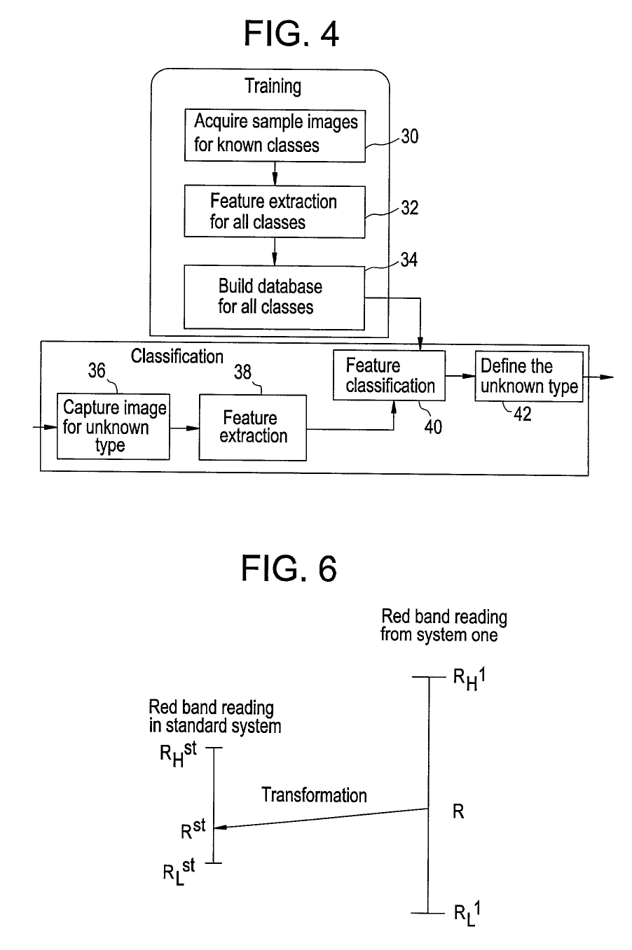

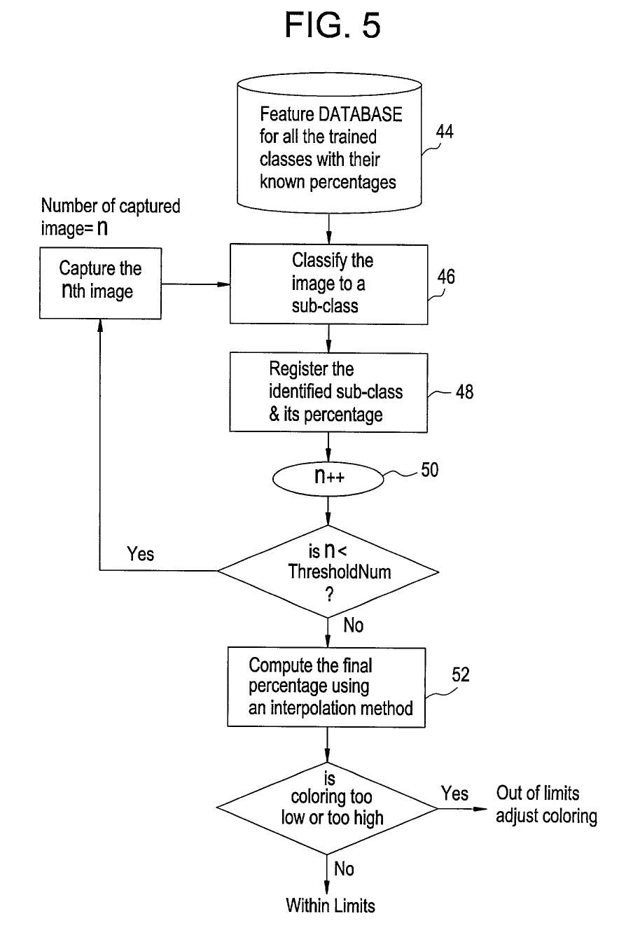

With reference to FIG. 4, system training is accomplished by tracking color characteristics which may include at least three dimensional (3D) histograms from transformed color images and storing these features in a database for the central computer 14. Other features or characteristics which may be included in addition to the three dimensional histograms are the mean, variance and hue derived from the color images. Using food products as an example, a database is built for each type/class of colored food product at 30. When a feature database for a class is built, a few images (five or more), from that class are normally sampled. Multiple images are used to improve the statistical results of the procedure. Feature extraction for all classes then occurs at 32 and a database for all classes is built at 34. As shown below, color features from different images are listed separately as a group even though they are stored together as the features from one color class. Color features may include the mean, variance, line and histogram from the transformed image.

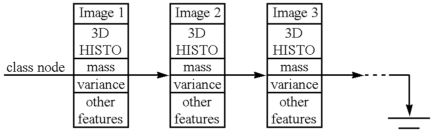

When an image of an unknown color product is acquired at 36 during a testing phase, its color features are extracted at 38 and compared at 40 with features from the training samples stored in the database. Then at 40, the color class of the training sample whose features provide the best match with those of the unknown color product is indicated. The decision is made based on a similarly measurement using a three dimensional histogram and other features.

Suppose two histograms are obtained from two color images, f(i, j, k) and g(i, j, k). The distance between two histograms in L^{p} metric can be expressed as

$${d}_{LP} ( f , g ) = {\sum }_{i , j , k} 1 f ( i , j , k ) - g ( i , j , k ) {1}^{p}$$

where p=1 represents absolute error, and p=2 represents a square error.

To classify an image, it actually has to be compared with all the features of the image sequences belonging to all the predefined classes.

The fundamental searching algorithm is present below.

for (all classes predefined in the database)
{

for (all the image features stored in each class)
{

if (the mean of the captured/transformed image satisfies
criteria)
{

if (any other features satisfy criteria)
{

measure d_{LP};
keep the average of d_{LP} for this class;

}

}

}

}
for (all the classes)
{
Locate the minimum of the average of d_{LP} computed above;
}

The class found to have the minimum of the average of d_{LP} will be assigned to the image.

To improve the results, it is also possible to use a voting scheme of n images to make a final decision.

The system is designed to be robust in the presence of camera noise, lighting noise, and variation of the illumination power. A voting scheme is adopted to compensate for the noise from the camera and illumination source.

The illumination invariant method of the present invention is performed both during the learning phase and the testing phase, and the results of the illumination invariant method are stored in the computer with the training image data for comparison with the result obtained during the testing phase.

In accordance with the illumination invariant method of the present invention, assuming there are two neighboring points A and B on an illuminated surface, by estimating the Red, Green and Blue (RGB) color intensities I, (i=R, G, B) derived from the color camera 26 at point A and point B, we can approximate

Iᵢ=Const.*Iᵢ^{incident}* Rᵢ^{reflectant}

Where Iᵢ^{incident} is the incident power at the ith band from the illumination source which is received by a surface point, and Rᵢ^{reflectant} is the surface reflectance of the ith band at the surface point.

As we know that, Iᵢ^{incident} is a function of illumination direction or angle. If, however, point A and point B are adjacent to one another, then we can assume that

Iᵢ^{incident}(A)=Iᵢ^{incident}(B).

If we take the ratio of the RGB intensities respectively for these points, we obtain,

$$\frac{{I}_{1} ( A )}{{I}_{i} ( B )} = \frac{Const . * {I}_{1}^{incident} ( A ) * {R}_{1}^{reflectant } ( A )}{Const . * {I}_{i}^{incident} ( B ) * {R}_{i}^{reflectant} ( B )} = \frac{{R}_{1}^{reflectant} ( A )}{{R}_{i}^{reflectant} ( B )}$$

This ratio is independent of the illumination source. This also means that the ratio is independent of the variation of the illumination power.

By taking the natural logarithm of this ratio, we obtain,

$$ln ( \frac{{I}_{i} ( A )}{{I}_{1} ( B )} ) = ln {I}_{1} ( A ) - ln {I}_{i} ( B ) = ln ( \frac{{R}_{1}^{reflectance} ( A )}{{R}_{t}^{reflectance} ( B )} )$$

This can be implemented by taking the logarithm of the image and subtracting neighbors.

Other methods of subtracting neighbors are less affected by noise resulting from the lighting and camera subsystems. We have utilized two different masks. The first mask (#1) is faster but the second mask (#2) is more effective in reducing the noise variation.

| | | |
|---|---|---|
| −1 | 2 | −1 |

Mask 1

| | | |
|---|---|---|
| −1 | | −1 |
| | 4 | |
| −1 | | −1 |

Mask 2

For any image, a natural logarithm is applied first, then one of the above masks is applied. A transformed image is thus formed at this point.

Many times when the food industry defines a coloring percentage, it is simply the weight ratio between the amount of coloring applied to the food product. In the training mode, coloring with various percentages are trained to build a feature database 44. Coloring with different percentages are defined as different sub-classes even though they actually belong to the same coloring type or super class. For example, we may have 5%, 5.5%, 6%, and 6.5% in terms of coloring percentages for a particular class. We define them as different sub-classes at 46 and 48, but they actually belong to a super class or the same type of coloring.

We simplify our case to illustrate the principle of a precise percentage measurement process. Suppose there are four (4) coloring percentages A%, B%, C% and D% available for training. A% and D% are the high percentage and low percentage limit, respectively. Suppose there is no other type of coloring. In the training mode, the system is trained with those samples, and they are defined as 4 subclasses.

Suppose the system has to make a final decision after n images at 50 when performing the classification process, and for these n images, n1, n2, n3 and n4 images are classified as A%, B%, C% and D% respectively.

The final color class percentage determined at 52 after n images will be:

$$\frac{n1 * A \% + n2 * B \% + n3 * C \% + n4 * D \%}{n1 + n2 + n3 + n4}$$

where n1+n2+n3+n4 is equal to n.

If the system has some instances of classifying the coloring as a different type coloring class, it first determines which class the coloring actually belongs to by a simple majority vote scheme. It then computes the percentage in the same fashion as above, except that n1+n2+n3+n4 will be less than n.

There are two major issues our system has dealt with successfully; that is the performance repeatability and system-wise repeatability. If, given the same testing samples, the system classifies/computes, in the case of food seasoning, seasoning percentages consistently within an error margin over an infinitely long time frame. With appropriate maintenance on lights but not replacing the CCD camera, we then call the system time-wisely repeatable.

Suppose there are two systems, one system is trained, the other one utilizes the training data from the first one. While in the classification process, if the two seasoning percentages computed from these two systems are within a small error of margin, we then call them system-wisely repeatable.

The repeatability issue is caused mainly by the camera and lighting system. It is very difficult for two different cameras to generate close enough (defined by our application requirements) results on the same object given the same lighting conditions. Two cameras have different noise distributions on images. Also, no two sets of lights will repeat on illumination, spectral structure, and noise. Furthermore, light output intensity decreases over time, making itself non-repeatable.

To achieve repeatability with two different camera and lighting systems, we are attempting to use a local first-order (or linear) calibration mechanism to calibrate the systems. Every system will be calibrated with respect to a so-called standard system, which can be any system. Its role is to obtain a set of training data. Once the training data is obtained, its task is completed. There is no requirement of maintaining the standard system. All the readings coming out of a non-standard system are transformed into the standard system domain first, and then the transformed data will be processed through the normal way.

To calibrate a system vs. a standard system, we first choose a series of standard colors almost evenly separated between 0 and 255 for all the red, green and blue (RGB) bands. For example, we could use color tiles with their values at (50,50,50), (100,100,100), (150,150,150), . . . (250,250,250). Any RGB readings within two standard colors will be calibrated with the help of their values. Let's pick two adjacent standard colors, and suppose their reading coming out of the standard system are (R_{L}^{ST},G_{L}^{ST},B_{L}^{ST}) and (R_{H}^{ST},G_{H}^{ST},B_{H}^{ST}). Let's call the system to be calibrated as System One, and it reads these two standard colors as (R_{L}¹,G_{L}¹,B_{L}¹) and (R_{H}¹,G_{H}¹,B_{H}¹) respectively. (See FIG. 6).

Suppose System One has a reading of (R′,G′,B′) on a pixel, to transform this reading into the standard reading, we apply the first order linear approximation as the following:

$$\frac{{R}_{H}^{1} - {R}_{L}^{1}}{{R}_{H}^{st} - {R}_{L}^{st}} = \frac{{R}^{′} - {R}_{L}^{′}}{{R}^{st} - {R}_{L}^{st}}$$

$$or$$

$${R}^{st} = \frac{{R}_{H}^{st} - {R}_{L}^{st}}{{R}_{H}^{1} - {R}_{L}^{1}} ( {R}^{′} - {R}_{L}^{1} ) + {R}_{L}^{st}$$

Similar results can be derived for the green and blue bands.

Before System One classifies data/image, it transforms the data using this formula, and then performs our core classification algorithm while using the training sets from the standard system.

The major benefit of achieving system-wise repeatability is that there is no need for different training data set for different systems, all the systems use the same training set. More importantly, all the systems produce the same classification result for the same sample even though systems may have different cameras and lightings.

The above method was further improved by calibrating through CCD cells. Each individual CCD array on a camera behaves differently. The readings at different regions on an image will be most likely different with the same color sheet. In the above, when we obtain (R_{L}^{ST},G_{L}^{ST},B_{L}^{ST}), (R_{H}^{ST},G_{H}^{ST},B_{H}^{ST}), (R_{L}¹,G_{L}¹,B_{L}¹) and (R_{H}¹,G_{H}¹,B_{H}¹), they are the average readings from all the CCD arrays (pixels). We further improved the accuracy by dividing the image into n and m cells, and obtain those values for each individual cell. When a system performs the calibration process, a pixel from its own cell will use the set of (R_{L}^{ST},G_{L}^{ST},B_{L}^{ST}), (R_{H}^{ST},G_{H}^{ST},B_{H}^{ST}), (R_{L}¹,G_{L}¹,B_{L}¹) and (R_{H}¹,G_{H}¹,B_{H}¹) obtained specifically for that cell.

This method further eliminates the uncertainties between the CCD arrays on each camera.

We claim:

1. A device for sensing the color characteristics of an object bearing nonuniform color patterns comprising;
a housing,
a support surface for an object bearing nonuniform color patterns positioned within said housing,
a digital color sensing and imaging device mounted within said housing and spaced above said support surface to provide color imaging signals from an object bearing nonuniform color patterns located on said support surface,
a plurality of light sources mounted within said housing between said digital color sensing and imaging device and said support surface, said light sources being equally spaced from said digital color sensing and imaging device and said support surface and being positioned with at least one light source on each of two opposed sides of said digital color sensing and imaging device,
and a computer connected to receive color imaging signals from said digital color sensing and imaging device.

2. The device of claim 1 wherein first and second light sources are mounted in opposed relationship at first and second sides respectively of said digital color sensing and imaging device and third and fourth light sources are mounted in opposed relationship at third and fourth sides respectively of said digital color sensing and imaging device, the distance between the opposed first and second light sources and the distance between the opposed third and fourth light sources being within the range of from one to two times the distance from the light sources to the support surface.

3. The device of claim 1 wherein said housing includes a top wall and spaced, opposed sidewalls extending from said top wall to define an imaging chamber, said digital color sensing and imaging device including a CCD camera, said camera and light sources being mounted within said imaging chamber.

4. The device of claim 3 wherein first and second light sources are mounted in opposed relationship at first and second sides respectively of said CCD camera and third and fourth light sources are mounted in opposed relationship at third and fourth sides respectively of said CCD camera, the distance between the opposed first and second light sources and the distance between the opposed third and fourth light sources being within the range of from one to two times the distance from the light sources to the support surface.

5. The device of claim 4 wherein said support surface is formed by a movable conveyor which passes beneath said imaging chamber.

6. The device of claim 4 wherein said light sources are linear light sources.

7. The device of claim 6 wherein said light sources are elongate fluorescent light sources.

8. The device of claim 7 wherein the distance between the opposed first and second light sources and the distance between the opposed third and fourth light sources is 1.4 times the distance from the light sources to the support surface.

9. A method for inspection of a product bearing nonuniform color patterns which includes:
using a digital color sensing and imaging device and lighting system to obtain a color image from a plurality of test surfaces having different desired nonuniform color patterns,
storing the color images from the test surfaces, as reference images,
using the digital color sensing and imaging device and lighting system to obtain a color image from a product bearing nonuniform color patterns and
comparing the color image from the product bearing nonuniform color patterns with the stored reference images to identify the closest reference image for classification of the color image from the product.

10. The method of claim 9 which includes obtaining and storing at least one characteristic for each reference image and obtaining the same characteristic for the color image from the product bearing nonuniform color patterns and comparing each separate characteristic for the color image from the product bearing nonuniform color patterns with the same stored characteristic for each reference image.

11. The method of claim 10 wherein a plurality of separate characteristics stored for each reference image and the same plurality of characteristics are obtained for the color image from the product bearing nonuniform color patterns and compared with the same stored characteristic for each reference image.

12. The method of claim 9 wherein each reference image from a test surface is stored as indicative of a class and different percentages of color for each said reference image are obtained and stored as subclasses within the class indicated by each said reference image, the color image from said product bearing nonuniform color patterns being first compared with the reference images to identify the closest reference image to provide the class of the color image from the product, the color image from said product bearing the nonuniform color patterns next being compared with all stored subclasses within the class identified to identify the stored subclass closest to the nonuniform color patterns of the product to identify a subclass for the product nonuniform color patterns.

13. The method of claim 12 which includes obtaining and storing a plurality of separate characteristics for each reference image and obtaining the same plurality of separate characteristics for the color image from the product bearing nonuniform color patterns and comparing each separate characteristic for the color image from the product bearing nonuniform color patterns with the same stored characteristic for each reference image.

14. The method of claim 13 which includes obtaining and storing a plurality of separate characteristics for each subclass which are the same as the separate characteristics stored for each reference image, and comparing each separate characteristic for the color image from the product bearing nonuniform color patterns with the same stored characteristic for each subclass within the identified class.

15. The method of claim 14 wherein the plurality of separate characteristics stored for each reference image include a mean, variance and histogram for each reference image.

16. The method of claim 9 which includes obtaining red, green and blue intensities for a first area of the product bearing nonuniform color patterns,
obtaining the logarithm of the red, green and blue color intensities for the first area as a first logarithm,
obtaining separate red, green and blue color intensities for at least second and third areas of the product bearing nonuniform color patterns which are adjacent to said first area, as second and third color intensities respectively,
obtaining the ratio of the second and third color intensities and the logarithm of said ratio as a second logarithm, and
subtracting said second logarithm from said first logarithm.
